(19) United States
(12) Patent Application Publication
(10) Pub. No.: US 2025/0225157 A1
(43) Pub. Date: Jul. 10, 2025

(54) CONFIDENTIAL INFORMATION PROCESSING APPARATUS, OPERATION METHOD THEREOF, AND DATA TRANSMISSION AND RECEPTION SYSTEM

(71) Applicant: FUJIFILM Corporation, Tokyo (JP)

(72) Inventor: Shinnosuke SONODA, Tokyo (JP)

(73) Assignee: FUJIFILM Corporation, Tokyo (JP)

(21) Appl. No.: 19/092,859

(22) Filed: Mar. 27, 2025

(30) Foreign Application Priority Data
Sep. 28, 2022 (JP) 2022-155309

(51) Int. Cl. G06F 16/31

(52) U.S. Cl. CPC G06F 16/325

(57) ABSTRACT

A confidential information processing apparatus according to the present invention includes a processor, in which the processor is configured to: acquire log data to be transmitted between apparatuses constituting a blockchain network; discriminate a text string of the log data; set a specific text based on a pre-setting as a mark; detect a text string of the log data based on the specific text, in the log data, as sensitive information; and perform a conversion process of converting the text string of the sensitive information into a different text or symbol.

### CROSS-REFERENCE TO RELATED APPLICATIONS

This application is a Continuation of PCT International Application No. PCT/JP2023/026556 filed on 20 Jul. 2023, which claims priority under 35 U.S.C § 119(a) to Japanese Patent Application No. 2022-155309 filed on 28 Sep. 2022. The above application is hereby expressly incorporated by reference, in its entirety, into the present application.

### BACKGROUND OF THE INVENTION

### 1. Field of the Invention

The present invention relates to a confidential information processing apparatus, an operation method thereof, and a data transmission and reception system.

### 2. Description of the Related Art

In a blockchain network, there is no central administrator, and each node has independent authority and constitutes the network. In addition, in a case of transmitting log data to the network, it is necessary to protect personal information and confidential information.

JP2019-53146A describes that a content of an encryption target location in a source program is protected not to be estimated, and WO2019/244949A (corresponding to US2021/0183486A1) describes that, in a case of medical data connection between hospitals by using a P2P database, personal information is specified by using a classifier, a de-personalization process is performed on the personal information, and the resultant is transmitted.

### SUMMARY OF THE INVENTION

On the other hand, particularly in a consortium-typed blockchain network that spans multiple industries, it is rare that an administrator of each node has the same information technology (IT) literacy, and there is often a substantial overall management organization. Meanwhile, even in such a case, each node has independent authority, and thus it is not possible to directly work by the management organization in a case of occurrence of a failure or a case of a function update.

In order to recover from the failure, the management organization can take a method of troubleshooting by analyzing the log data provided from the network configuration organization, but there is a risk that “sensitive information” such as key information, a password, and raw data is included in the log data in this case. In a case where the sensitive information is included in the log data, the sensitive information is leaked to the network configuration organization, and the leakage of the sensitive information leads to a decrease in tamper resistance of the node or a deterioration in reliability. On the other hand, in a case where the data including the sensitive information is not uploaded, it is not possible to perform system maintenance such as recovery work in a case where a problem occurs in the storage of the log data.

An object of the present invention is to provide a confidential information processing apparatus, an operation method thereof, and a data transmission and reception system, capable of performing system maintenance across organizations while preventing leakage of sensitive information in a blockchain.

According to an aspect of the present invention, there is provided a confidential information processing apparatus comprising a processor, in which the processor is configured to: acquire log data to be transmitted between apparatuses constituting a blockchain network; discriminate a text string of the log data; set a specific text based on a pre-setting as a mark; detect a text string of the log data based on the specific text, in the log data, as sensitive information; and perform a conversion process of converting the text string of the sensitive information into a different text or symbol.

It is preferable that in the log data, a text string including the specific text is detected, as the sensitive information.

It is preferable that in the log data, a text string interposed before and after the specific text or a text string including the specific text is detected, as the sensitive information.

It is preferable that a dictionary function is used for discriminating the text string of the log data, and a text string that is not discriminated based on the dictionary function is detected, as the sensitive information.

It is preferable that a text string interposed before and after a text string that is not discriminated based on the dictionary function is detected, as the sensitive information.

It is preferable that a text string after conversion by the conversion process is determined, according to a type of the sensitive information.

It is preferable that in the pre-setting, a rule for listing the specific text, a rule for classifying a type of the sensitive information, and a rule for determining a conversion range are applied to the conversion process.

It is preferable that in the pre-setting, statistical data of the conversion process on the sensitive information in past is applied to the conversion process.

It is preferable that conversion-processed log data is transmitted to another apparatus constituting the blockchain network, and feedback data having an analysis result of the conversion-processed log data is acquired from the other apparatus.

It is preferable that in the pre-setting, an update of a detection target of the sensitive information based on the analysis result is received.

It is preferable that the conversion process and transmission for each line of the log data are performed, in response to a command operation by another apparatus constituting the blockchain network.

It is preferable that in a case where the conversion process is performed in response to the command operation, a prohibited operation including an acquisition operation of the sensitive information by the other apparatus is determined.

It is preferable that the prohibited operation includes any of a viewing, creating, editing, or deleting operation for a directory unrelated to system maintenance, in addition to editing and deleting of the text string of the log data.

It is preferable that there is provided a data transmission and reception system including the confidential information processing apparatus.

According to another aspect of the present invention, there is provided an operation method of a confidential information processing apparatus, the method comprising: a step of acquiring log data to be transmitted between apparatuses constituting a blockchain network; a step of discriminating a text string of the log data; a step of setting a specific text based on a pre-setting as a mark; a step of detecting a text string of the log data based on the specific text, in the log data, as sensitive information; and a step of performing a conversion process of converting the text string of the sensitive information into a different text or symbol.

According to the present invention, it is possible to perform system maintenance across organizations while preventing leakage of sensitive information in a blockchain.

### BRIEF DESCRIPTION OF THE DRAWINGS

FIG. 1 is a schematic diagram of a data transmission and reception system.

FIG. 2 is a block diagram illustrating a function of a device constituting a node 11 and a confidential information processing apparatus.

FIG. 3 is a block diagram illustrating a function of a sensitive information detection unit in the confidential information processing apparatus.

FIG. 4 is an explanatory diagram of exchanging log data between two organizations.

FIG. 5 is an explanatory diagram in a case where the log data is automatically transmitted.

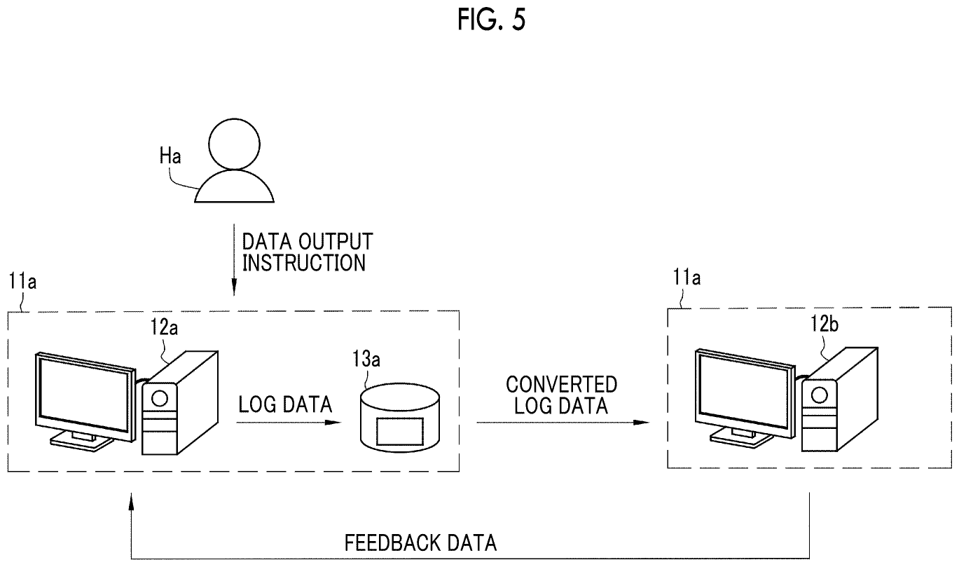

FIG. 6 is a flowchart illustrating a series of flows of a conversion process and transmission of the log data.

FIG. 7 is an explanatory diagram in a case where the log data is transmitted by a command operation according to a second embodiment.

### DESCRIPTION OF THE PREFERRED EMBODIMENTS

### First Embodiment

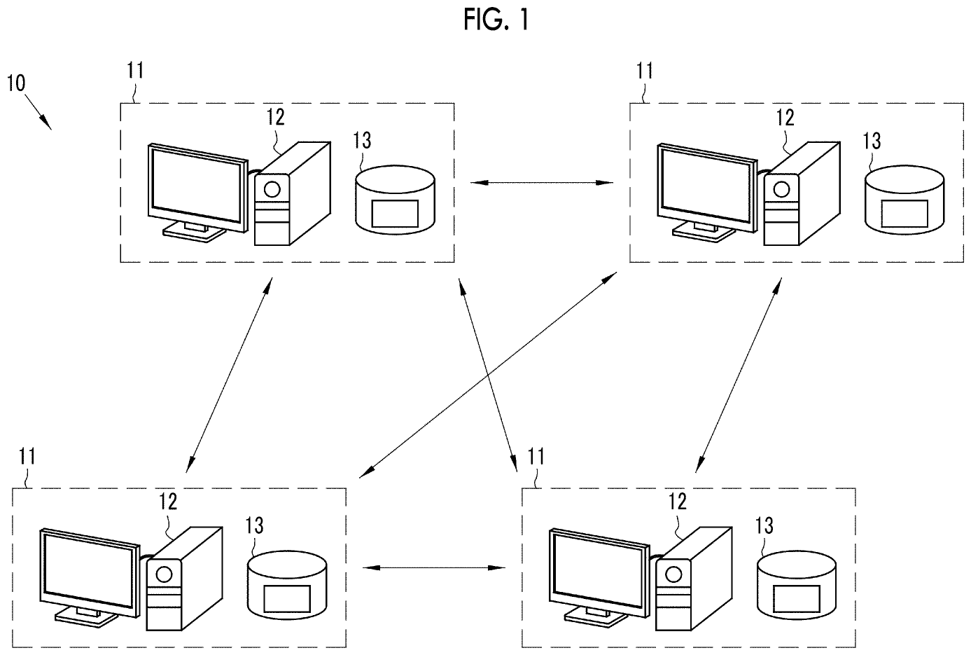

As illustrated in FIG. 1, a data transmission and reception system 10 is a blockchain network configured with a plurality of nodes 11, and each node 11 is managed by a configuration organization having independent authority from each other. The node 11 includes a device 12 and a confidential information processing apparatus 13. The device 12 is an information processing terminal that can transmit and receive information comprising a storage medium and a processor, and saves register data including log data by using the blockchain network. In a case where the device 12 transmits information such as log data to another node 11, the confidential information processing apparatus 13 detects sensitive information such as key information, a password, or raw data, and performs a conversion process.

The reception of the log data may be performed by the device 12, and the transmission of the log data may be performed by the confidential information processing apparatus 13 that executes the conversion process, or the confidential information processing apparatus may transmit the conversion-processed log data via the device 12 constituting the same node 11. The functions of the device 12 and the confidential information processing apparatus 13 may be realized by a confidential information processing apparatus that is one device.

The blockchain network has, for example, a consortium type in which a plurality of limited companies participate. In that case, the participating companies may be in different industries. The node 11 handles all log data of the self-organization to transmit log data to be used for recovery in a case of a system failure or the like in an automatic or manual manner. The transmission and reception of the normal log data to and from the node 11 of another organization are automatically performed, and can also be manually executed in a case of recovery from a system failure or the like.

In addition, in a case where the log data on which the conversion process is performed is received, an organization on a reception side can perform an analysis by using the device 12 to obtain an analysis result of a conversion process situation of the log data for the sensitive information. In addition, the analysis result can be transmitted to the device 12 of the organization on the transmission side as feedback data. The device 12 that receives the feedback data may reflect the feedback data on the confidential information processing apparatus 13 belonging to the organization to which the device 12 belongs.

In some cases, a format of the log data is different for each node 11, and it is preferable that each of the confidential information processing apparatus 13 or a program for realizing the function of the confidential information processing apparatus 13, which is included in each node 11, has compatibility.

The node 11 constituting the data transmission and reception system 10 and the other organization has the device 12 and the confidential information processing apparatus 13. The device 12 and the confidential information processing apparatus 13 are connected, and in a case where the device 12 transmits information, such as log data, to the other organization in the data transmission and reception system 10, the information is transmitted via the confidential information processing apparatus 13.

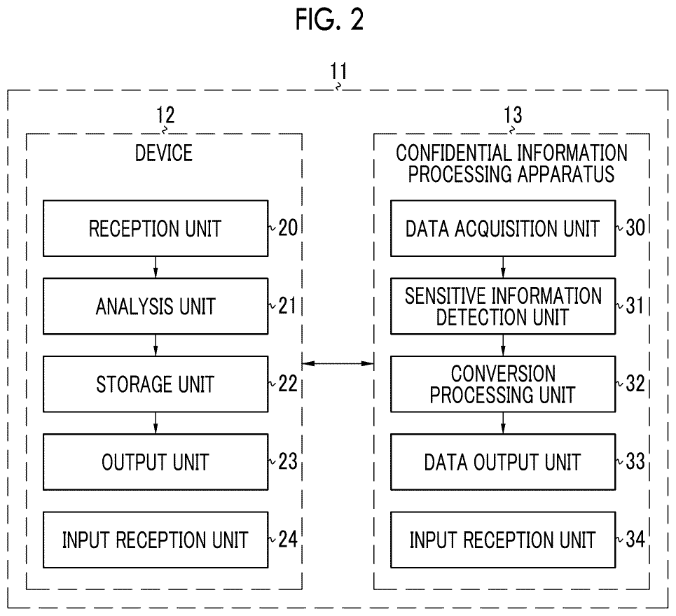

As illustrated in FIG. 2, the device 12 realize s functions of a reception unit 20, an analysis unit 21, a storage unit 22, an output unit 23, and an input reception unit 24. In addition, the confidential information processing apparatus 13 realize s functions of a data acquisition unit 30, a sensitive information detection unit 31, a conversion processing unit 32, a data output unit 33, and an input reception unit 34. Each of the device 12 and the confidential information processing apparatus 13 is a computer, such as a personal computer or a workstation, in which an application program for realizing a predetermined function is installed. The computer comprises a central processing unit (CPU) which is a processor, a memory, a storage, and the like, and realizes various functions by a program or the like stored in a storage.

The reception unit 20 acquires the log data received from the node 11 of the other organization or log data of a relevant device of the self-organization. The log data acquired from the node 11 of the other organization is transmitted to the analysis unit 21, and the log data of the self-organization is transmitted to the storage unit 22. In addition, a log data output instruction is also received.

The analysis unit 21 analyzes the log data received from the other organization, and determines information included in the log data and a type of the information. In addition, it is preferable to determine whether or not a conversion process is performed and a portion on which the conversion process is performed, and to make it searchable by an annotation or the like. An analysis result may be output in a text format or the like. The conversion process will be described below. The log data after the analysis and the analysis result output such as the annotation is transmitted to the storage unit 22. In addition, the analysis result of the log data of the other organization is transmitted to a node as a transmission source as feedback data.

The storage unit 22 saves the log data of the self-organization and the other organization, and relevant information of the log data, such as the analysis result created by the analysis unit 21. The log data of the self-organization is transmitted to and shared with the node 11 of the other organization in the blockchain network unless otherwise designated. The log data of the other organization is output in a case of system maintenance.

The output unit 23 outputs the log data of the self-organization or the other organization in response to the log data output instruction. In a case of outputting the log data of the self-organization, the log data is transmitted to the confidential information processing apparatus 13, and in a case of outputting the log data or the feedback data of the other organization, the log data or the feedback data is transmitted to the node 11 as the transmission source.

The input reception unit 24 can receive an operation of a user, who is an administrator or the like of an organization to which the node 11 belongs, via a user interface (UI) or the like. The input is performed via a user interface (not illustrated) such as a mouse operation or a keyboard operation. The input includes an instruction regarding the output of the log data, an instruction regarding the control of the confidential information processing apparatus 13, and the like.

Specific functions of the data acquisition unit 30, the sensitive information detection unit 31, the conversion processing unit 32, the data output unit 33, and the input reception unit 34 provided in the confidential information processing apparatus 13 will be described below.

The data acquisition unit 30 acquires log data to be transmitted to the node 11 of the other organization from the device 12. The log data to be acquired is all log data to be transmitted, and is transmitted to the sensitive information detection unit 31.

The sensitive information detection unit 31 detects sensitive information included in the log data, classifies a type of the sensitive information, and determines a range of a text string on which a conversion process is to be performed by the conversion processing unit 32. The sensitive information detection unit 31 detects a text string including a specific text or a text string interposed before and after the specific text or the text string including the specific text as the sensitive information from the log data based on a content of a pre-setting.

The conversion processing unit 32 performs the conversion process of the log data on a conversion range determined according to the pre-setting. In the conversion process, it is necessary to change a text string of the conversion range in the log data such that the sensitive information, which is an original text string, cannot be specified, while the type of the sensitive information can be discriminated from a text string after conversion, which is data to be used for recovery in a case where a system failure occurs or the like. Therefore, a text, a text string, or a symbol after conversion by the conversion process is determined according to the type of the sensitive information. In addition, the conversion process includes a mask process of masking a text in the conversion range with black-painting or the like.

For example, a text string detected as sensitive information is converted into a hash value using a hash function, and a text string of which only a type of the sensitive information can be discriminated is added before and after the hash value. Alternatively, the sensitive information is converted into a certain text string for each type of sensitive information. The converted text string has a pattern in which the same text or text string, such as “AAAA” or “ABAB”, is repeated. In addition, in order to easily discriminate a type of the text string after conversion, the text string may be converted into a text string such as “--PASSWORD--” or “--PRIVATE_KEY--”. The organization that receives the conversion-processed log data (converted log data) by the conversion process capable of discriminating the type of sensitive information can hold the minimum information necessary for system maintenance, such as the type of sensitive information, and can prevent viewing of confidential information, personal information, and the like.

The data output unit 33 outputs the conversion-processed log data in which the sensitive information is converted by the conversion process, from the confidential information processing apparatus 13 to the node 11 of the other organization.

The input reception unit 34 receives an instruction from an administrator of each organization or receives an input of feedback data to be described below.

In a normal operation, various types of data are accumulated in the node 11 managed by each organization. In a case of participating in the blockchain network, log data or the like is exchanged and stored. In this case, the conversion process of converting the sensitive information is performed, and the reception side receives and stores the conversion-processed log data.

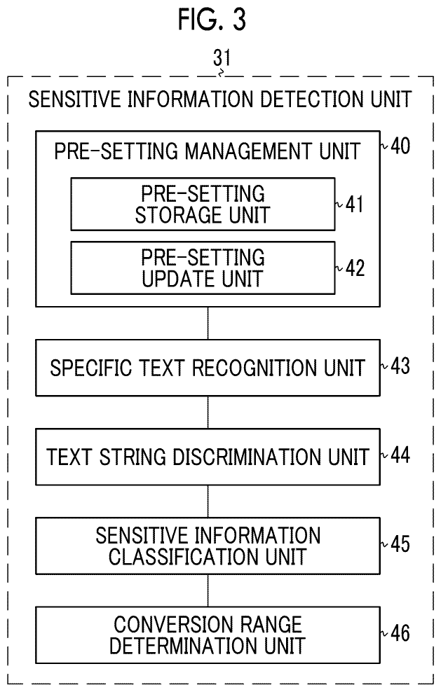

As illustrated in FIG. 3, the sensitive information detection unit 31 comprises a pre-setting management unit 40 further having functions of a pre-setting storage unit 41 and a pre-setting update unit 42, a specific text recognition unit 43, a text string discrimination unit 44, a sensitive information classification unit 45, and a conversion range determination unit 46, and specific functions will be described below.

The pre-setting management unit 40 manages a pre-setting, which is a rule set in advance for detection of sensitive information, classification of a type of sensitive information, and a conversion range. Each rule is also updated by using statistical data, in addition to the rule set in advance. The pre-setting is stored in the pre-setting storage unit 41, and the update by a manual setting by an administrator or a reception of feedback data is received via the pre-setting update unit 42.

The pre-setting applied to the detection and a conversion process of the sensitive information includes at least a rule in which a specific text serving as a mark for detecting the sensitive information is listed, a rule for classifying the type of the sensitive information according to the discriminated text string, and a rule for determining a conversion range according to the type of the sensitive information. In addition, statistical data of the conversion process on the sensitive information in the past is also used for the pre-setting. In addition, a rule for performing the conversion process according to the type of the sensitive information may be set.

The pre-setting storage unit 41 has a function of performing writing and reading with respect to a storage region, and stores the pre-setting. The stored pre-setting is referred to in detecting and classifying sensitive information and determining a conversion range and a conversion processing method. In addition, the storage region is also referred to in a case of updating a content of the pre-setting via the pre-setting update unit 42.

The pre-setting update unit 42 updates the pre-setting based on a user operation or a reception of feedback data. The update is addition or change of the rule or the statistical data, and the updated content is stored in the pre-setting storage unit 41. The updated pre-setting is used for subsequent detection of sensitive information. The update operation is performed, for example, to more accurately execute the conversion process on the sensitive information by changing or adding a rule for a text string that is not detected or is erroneously detected in a dictionary function or a natural language processing to be described below. In a case where the update of the pre-setting is automatically performed, it is preferable to use statistical data including a plurality of times of examples, instead of the example of once of the non-detection or the erroneous detection.

The statistical data used for the pre-setting is a relationship or the like between information before and after the conversion and the text string of the sensitive information, which are difficult to set by the rule but are frequently used. By using the sensitive information statistical data or the individual definition, it is possible to prevent the sensitive information from being undetected.

The specific text recognition unit 43 recognizes a specific text having a high possibility of being sensitive information based on the pre-setting. The specific text is one text or a plurality of texts used in a predetermined combination, and is used for discriminating whether or not the text is sensitive information. The recognized specific text is provided with an annotation or the like.

The specific text is a text or a symbol used for a specific expression, such as an at-sign (@), a colon (:), a hyphen (-), or a period (.), for example. In addition, a combination of a plurality of texts existing in a specific order in a certain range may be recognized as the specific text, instead of one text. For example, the symbol is a text or a text string, such as a curly brace ({ }) or a quotation mark (“ ”)

The text string discrimination unit 44 discriminates a text string such as a word from the acquired log data. Specifically, the log data is discriminated for a name, a numerical value, or a text string with some meaning, by using a dictionary function registered in advance for the log data or performing named entity recognition of the natural language process. As a result, the text string is classified into a text string that can be discriminated and a text string that cannot be discriminated.

The text string that can be discriminated by the dictionary function is a text string having some meaning such as a word, and classification may be performed according to the meaning of the text string by using the dictionary function. In particular, there are a time expression, a money amount expression, a telephone number, and a proper noun such as a personal name or a place name in the classification, and the proper noun is particularly likely to be sensitive information.

The text string that cannot be discriminated by the dictionary function, and a text having a large number of digits among the text strings is a password, a private key, or the like, in some cases. Therefore, a text string having a certain number of texts or more, for example, 8 texts or more, which cannot be discriminated by the dictionary function is detected as sensitive information. On the other hand, in the password or the private key, particularly, in a case where a text string having a large number of texts is manually set by a person with low IT literacy or is accidentally included, some word may be included. Therefore, even in a case where a word is detected in a text string, the text string that cannot be discriminated by the dictionary function and occupies a certain ratio, for example, half or more is detected as sensitive information.

By the pre-setting, a combination of text strings or a text string or the like including a specific text having a high possibility of including sensitive information within a certain range can also be discriminated. For example, there are “http://” or “https://” for discriminating a uniform resource locator (URL), “Ltd.”, “Corp.”, “Inc.” for indicating a company name, “Mr.”, “Ms.”, “Mrs.” for a title of honor, and the like. In addition, a text string obtained by combining texts or words, for example, text strings such as “-----BEGIN PRIVATE KEY-----” and “-----END PRIVATE KEY-----” indicating a start and an end of a private key are discriminated.

In the natural language process, for example, a text string discrimination process of the log data is executed by using a pre-trained content. The text string discrimination unit 44 has a function of a trained model necessary for the text string discrimination process. That is, the text string discrimination unit 44 is a computer algorithm consisting of a neural network that performs machine learning, determines the presence or absence of a meaningful text string of log data input according to the learning content, and performs specific inference regarding a type of the text string in a case where there is the meaningful text string, and acquires a discrimination result. The discrimination result acquires the discriminated meaningful text string and the type thereof, and information such as a position in the log data. The discrimination result is used for detecting sensitive information.

The sensitive information classification unit 45 detects sensitive information and classifies the type of sensitive information from the specific text or text string set as a mark by the specific text recognition unit 43 and the text string discrimination unit 44. In the discrimination of the sensitive information, the pre-setting stored in the pre-setting storage unit 41 is referred to.

A proper noun using a plurality of words may be sensitive information together with a text string including a specific text and a text string immediately before or after the text string. Therefore, in a case where a text string including a specific text, which is set as a rule in advance, is detected, the text string in a certain range is detected as sensitive information. For example, text strings of “Ltd.”, “Corp.”, and “Inc.” used in a company name are detected as sensitive information together with text strings located immediately before the text strings, and text strings of “Mr.”, “Ms.”, and “Mrs.” are detected as sensitive information together with text strings located immediately after the text strings. Since it is rare that one proper noun is continued even in a case where the proper noun in log data is line feed, a range of a text string to be detected is limited to the same line, that is, the same line up to the line feed code, at the maximum together with a text string including a specific text. It is preferable to use a natural language process and named entity recognition to detect which part of the text string immediately before or after is sensitive information. On the other hand, it is preferable that a proper noun or the like having a long name that frequently appears in each organization is added to the pre-setting as sensitive information.

The conversion range determination unit 46 determines a range in which a conversion process of each piece of sensitive information is to be executed, according to a type of sensitive information classified by the sensitive information classification unit 45. Information on the determined conversion range is associated with each log data, and is transmitted to the conversion processing unit 32. Based on the pre-setting, the specific text recognized by the specific text recognition unit 43 and the text string discriminated by the text string discrimination unit 44 are set as marks, and a range of the text string in the log data in which the conversion process is to be performed is determined. The determination of the range in which the conversion process is to be performed is detection of sensitive information. The range in which the conversion process is performed varies depending on a classification result by the sensitive information classification unit 45. It is determined that the range in which the conversion process is to be performed is sensitive information, and the log data having a location detected as the sensitive information is transmitted to the conversion processing unit 32.

Detection of sensitive information that is a user ID and a password used for basic authentication or the like will be described. For example, in a case where a combination of a user ID and a password is “https://userid:password@example.com” as a format output to log data, the specific text recognition unit 43 recognizes a colon (:) and an at-sign (@), and the text string discrimination unit 44 discriminates a text string of “https://”. The sensitive information classification unit 45 detects a region interposed between “https://” and “@”, which does not have a space and a line break and is included in one line as sensitive information, and classifies a type as a “set of ID and password”. In addition, a colon (:) may be used as a base point in the interposed region, and a first half portion may be further discriminated as a “user ID” and a second half portion may be further discriminated as a “password”. In that case, the reliability degree as the sensitive information is higher than that of the “set of ID and password”. In the conversion range determination unit 46, all the ranges classified as the “set of ID and password” are set as a conversion range, and in a case where the ranges are divided into “user ID” and “password”, each of the ranges is set as the conversion range.

Detection of sensitive information that is a private key will be described. For example, in a case where text strings of “-----BEGIN PRIVATE KEY-----” and “-----END PRIVATE KEY-----” are output as log data of a private key, the specific text recognition unit 43 recognizes a hyphen (-), and the text string discrimination unit 44 discriminates the text strings of “BEGIN PRIVATE KEY” and “END PRIVATE KEY”. The sensitive information classification unit 45 detects a region interposed between “-----BEGIN PRIVATE KEY-----” and “-----END PRIVATE KEY-----” as sensitive information, and classifies a type as “private key”. There may be a space or a line break in the interposed region. That is, “-----BEGIN PRIVATE KEY-----” is immediately before the “private key”, and “-----END PRIVATE KEY-----” is immediately after the “private key”. In the conversion range determination unit 46, all the ranges classified as “private key” are set as the conversion range.

Regarding information on which the conversion process is to be performed, the conversion process may be performed on information that is not originally treated as log data, is not written to the blockchain, and is not information necessary for recovery in a case where a failure occurs, as sensitive information. For example, the conversion process may be performed on a document and the like in an XML format, a JSON format, and a YAML format as the sensitive information.

Detection of the document in the XML format, in the JSON format, and in the YAML format will be described. In the detection of the document format, first, a text string representing a start point and a text string representing an end point, which are determined by a rule of each document format, are detected from a text string included in log data, and the corresponding document format is estimated. Next, by determining that a region interposed between the start point and the end point is a valid text string in the estimated format of each document, it is detected whether or not a text string interposed between the start point and the end point is sensitive information. The text string rule corresponding to each document format is stored in advance as a pre-setting.

In a case of the XML format, the specific text recognition unit 43 and the text string discrimination unit 44 specify “<xxx>” and “</xxx>” in a case where any alphanumeric text is x. The sensitive information classification unit 45 detects an entire region interposed between “<xxx>” at a start of the document and “</xxx>” at an end of the document as sensitive information, and estimates a type as “XML format document”. After the estimation, it is determined whether or not the interposed region is valid as the registered XML format. In a case where it is determined that the interposed region is valid, the interposed region is classified as “XML document” for sensitive information. In a case where it is determined that the interposed region is not valid, detection and classification are performed to determine whether or not the interposed region is another type of sensitive information.

In a case of the JSON format, the specific text recognition unit 43 recognizes a start curly bracket ({) and an end curly bracket (}). The sensitive information classification unit 45 detects, as sensitive information, an entire region interposed between the start curly bracket ({) at a beginning of any line of log data and the end curly bracket (}) at an end of any line after the line with the start curly bracket ({), and estimates a type as “JSON format document”. After the estimation, it is determined whether or not the interposed region is valid as the JSON format registered in advance. In a case where it is determined that the interposed region is valid, the interposed region is classified as “JSON document” for sensitive information. In a case where it is determined that the interposed region is not valid, detection and classification are performed to determine whether or not the interposed region is another type of sensitive information.

In a case of the YAML format, the specific text recognition unit 43 recognizes a colon (:). In a case where any text is y, the sensitive information classification unit 45 detects a region that is started with “yyy:” which is at a beginning of a line in any line of log data and which is followed by zero or more spaces or tabs and that is set up to a region that is valid as a YAML format, as sensitive information, and classifies the region, as “YAML document”.

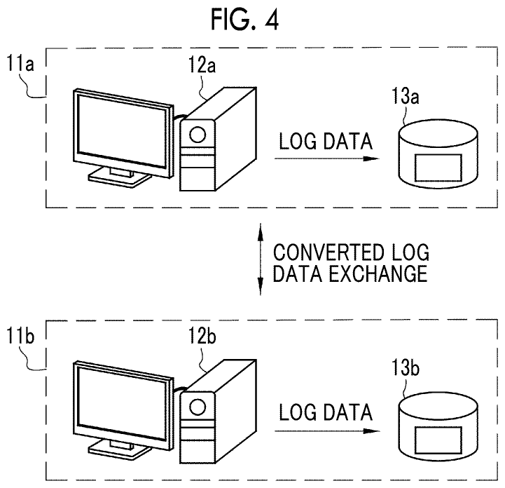

As illustrated in FIG. 4, transmission of log data between a node 11a managed by an organization A and a node 11b managed by an organization B among a plurality of nodes constituting the data transmission and reception system 10, such as a blockchain network, will be described. The node 11a includes a device 12a and a confidential information processing apparatus 13a, and the node 11b includes a device 12b and a confidential information processing apparatus 13b. Before log data in the node 11a is output, log data held by the device 12a is transmitted to the confidential information processing apparatus 13a.

The confidential information processing apparatus 13a performs detection and a conversion process of sensitive information on the acquired log data, based on a pre-setting. The specific text recognition unit 43 recognizes a specific text that is a mark of the sensitive information based on the pre-setting. The text string discrimination unit 44 discriminates a text string serving as a mark of the sensitive information including the specific text. The sensitive information classification unit 45 detects a text string within a certain range from the text or the text string set as the mark as the sensitive information, and specifies a type of the sensitive information. The conversion range determination unit 46 determines a range for a conversion process of converting the text string into a different text string for each type. The conversion processing unit 32 performs the conversion process on the determined range in the log data to convert the log data into conversion-processed log data.

The node 11a transmits the conversion-processed log data to the device 12b in the node 11b. The device 12b analyzes the acquired conversion-processed log data, and saves the log data, together with an analysis result. The log data on which the confidential information processing apparatus 13a performs the conversion process is all the log data transmitted from the node 11a to the node 11b, and it is preferable that the conversion process is performed on each line of the log data.

The device 12b, which is a reception side, that receives the conversion-processed log data performs analysis on the conversion-processed log data. The device 12b analyzes what information the acquired conversion-processed log data has. For example, a natural language process is performed on a portion of the log data, on which the conversion process is not performed, and a meaningful text string is extracted. A characteristic or type of the log data and the information included in the log data are obtained as the analysis result from the extracted text string. In a case where there is a range on which the conversion process is performed, data obtained from the text string after the conversion process is also used for the analysis. In a case where there is a text string on which the conversion process is not performed and which is likely to be sensitive information, it is preferable that feedback data includes the text string as an omission from the conversion process. The type of log data including the sensitive information on which the conversion process is performed is determined. For example, the type is a user ID and a password, a private key, a document, a contact, or the like. The node 11a acquires feedback data having the analysis result of the conversion-processed log data from the node 11b which is a reception side. The node 11a refers to the analysis result included in the acquired feedback data, and receives an update of a detection target of the sensitive information in the pre-setting based on the analysis result in a case where there is a defect such as omission of the sensitive information from the conversion process.

In the same manner, in the node 11b, the confidential information processing apparatus 13b performs a conversion process on log data output by the device 12b, converts the log data into conversion-processed log data, and transmits the conversion-processed log data to the node 11a. The data exchange is performed between the respective nodes 11 constituting the data transmission and reception system 10. The log data exchange in a normal operation is automatically performed.

Next, in the data transmission and reception system 10, an operation in a case where a system failure occurs and recovery is performed will be described. In order to determine a cause of the system failure occurrence and to recover from the system failure, transmission of conversion-processed log data by at least one of the nodes 11 is performed, the node 11 that receives the conversion-processed log data analyzes the conversion-processed log data, and performs feedback by using an analysis result. The log data transmission and the feedback for determining the cause of the system failure may be randomly performed between the respective nodes 11, and may be executed between specific nodes 11 by narrowing down candidates for the node 11 having a high possibility of the cause determination. In a case where there is a result that leads to the cause determination by the feedback, recovery work is performed based on a result. In a case where the result that leads to the cause determination is not obtained, the data exchange is repeated.

The feedback is to transmit, as the analysis result, at least one of whether or not the analysis is normally performed, whether or not there is an unnatural analysis result, or a comparison result between the analyzed conversion-processed log data and an analysis content stored during the normal operation, which is identical as the analyzed conversion-processed log data, to the node 11a. The log data to be transmitted is the entire log data of the node 11a. The node 11a responds to the system failure based on the acquired feedback.

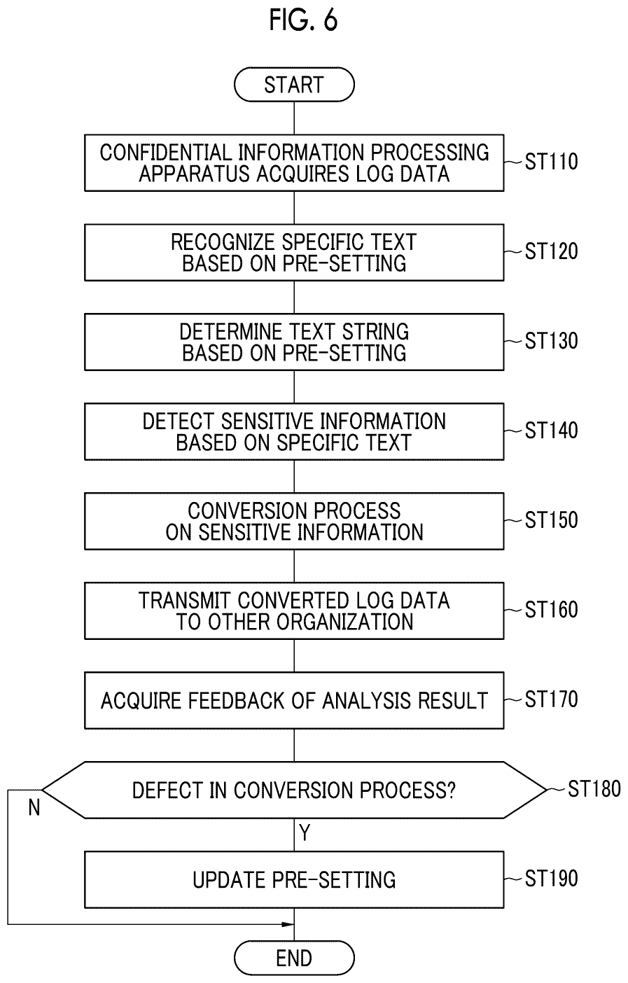

A series of flows of an operation for log exchange by the confidential information processing apparatus 13 according to the present embodiment will be described with reference to a flowchart illustrated in FIG. 6. The confidential information processing apparatus 13 acquires log data transmitted from the device 12 belonging to the same node 11 between apparatuses constituting a blockchain network (step ST110). A specific text that is a mark for sensitive information is recognized from the acquired log data based on a pre-setting (step ST120). In addition, a text string serving as the mark for the sensitive information is discriminated from the acquired log data, based on the pre-setting (step ST130). A text string within a certain range from a text or text string set as the mark is detected as the sensitive information, and a type in the sensitive information is classified (step ST140). A conversion process of converting the detected sensitive information into a text string different for each type is performed (step ST150). The node 11 transmits the conversion-processed log data to another organization (step ST160).

The other organization that is a destination to which the log data is transmitted analyzes the conversion-processed log data. The node 11 acquires feedback data including an analysis result (step ST170). In a case where there is a defect in the conversion process on the sensitive information based on the analysis result of the feedback data (Y in step ST180), the pre-setting is updated to eliminate the defect in the conversion process, and the transmission of the log data is ended (step ST190). In a case where the defect in the conversion process is not checked by the feedback (Y in step ST180), the transmission of the log data is ended without changing the pre-setting.

With the above contents, the detection of the sensitive information in the log data and the conversion process are performed, and thus the log data can be exchanged between the organizations while preventing the sensitive information from being leaked.

### Second Embodiment

In a second embodiment, transmission of log data is executed by a command operation by an administrator or the like of an organization on a transmission side, instead of a data output instruction by the administrator of the organization on the reception side in the first embodiment. The command operation may be issued from an operation of the device 12 or may be issued from an operation of the confidential information processing apparatus 13 having the function of the device 12. Other details are the same as those of the first embodiment.

For example, in a case where a trouble such as a system failure occurs in an organization A, log data is transmitted to an organization B for system maintenance for a cause determination and recovery. An administrator of the organization B recognizes a notification of the abnormality of the self-organization by an administrator Ha of the organization A, a warning message issued from the node 11a, and the like, and performs a command operation such as a data provision instruction from the organization B to the node 11a of the organization A.

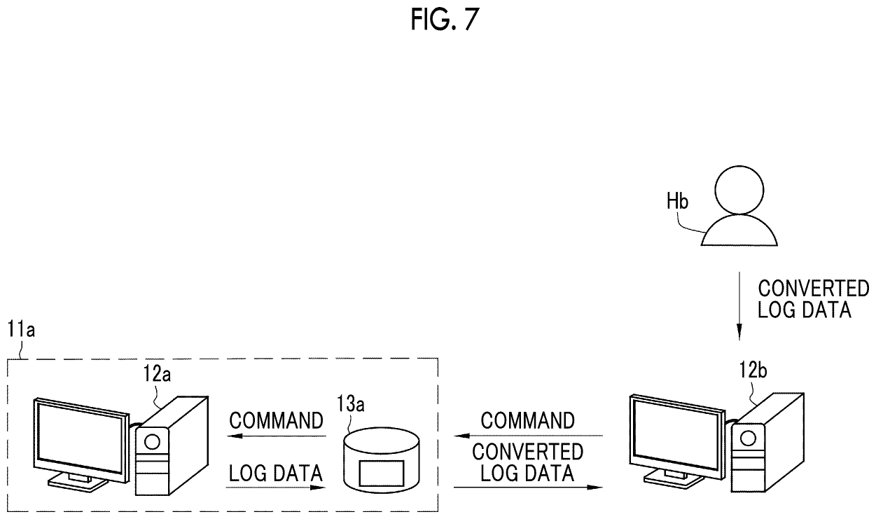

As illustrated in FIG. 7, in a case where log data of the organization A is acquired, an administrator Hb of the organization B transmits a command by a command operation to the node 11a. The node 11a transmits the conversion-processed log data converted by the confidential information processing apparatus 13a to the organization B, which is another organization, in response to the command. It is preferable that the device 12b that receives the conversion-processed log data performs an analysis process, and feeds back and the like an analysis result of the log data. The administrator Ha refers to the feedback of the analysis result acquired by the device 12a of the node 11a. The administrator Hb of the organization B involved in the determination of the cause of the system failure and the recovery is, for example, a substantial administrator or the like of the entire data transmission and reception system 10.

In a case where the organization B, which is a reception side of the log data, acquires the log data by a command operation, the administrator Hb of the organization B performs the command operation to cause the device 12b to output a command to request the log data to the organization A. The command issued from the device 12b in the node 11b is transmitted to the device 12a that stores the log data via the confidential information processing apparatus 13a in the node 11 of the organization A. Since the organization B indirectly accesses the device 12a of the organization A by the command operation and the command, the confidential information processing apparatus 13a restricts the received command.

A specific command is information such as the amount of log data to be obtained and a destination of the log data, and includes only the minimum instructions necessary for the transmission of the log data. The confidential information processing apparatus 13a that receives the command from the organization B determines an operation that is not related to or has low relation to the acquisition of the log data or system maintenance from the node 11 to which the confidential information processing apparatus 13a does not belong as a prohibited operation and does not receive the operation. Specifically, only a command having a high relevance to the log data acquisition is allowed to be input, and other operations, particularly the acquisition of sensitive information or operations having a specific possibility are restricted as prohibited operations. The prohibited operation includes not only an operation of editing and deleting a text string of the log data but also an operation of viewing, creating, editing, and deleting a directory unrelated to the system maintenance.

In a case of transmitting the log data from the node 11a of the organization A to the node 11b of the organization B in real time, the conversion process and the transmission of the log data of a small amount, for example, one line may be performed instead of outputting all the log data in a lump. In a case where the log data is transmitted by the command operation on a reception side, it takes time to execute the data output in a batch for all the log data, and a waiting time on the command operation side is long. In addition, in a case where a system failure occurs, it may be prioritized to grasp an outline abnormality rather than to grasp a detailed abnormality. Therefore, it is possible to efficiently respond to the system failure or the like by transmitting the log data line by line. One line of the log data is a range up to a line feed code set for each document of each format, instead of “folded-back” which may be changed by a display or the like provided by each node.

In the second embodiment, since the detection or the conversion process of the sensitive information is performed for each line, the maximum conversion range in a case where the conversion process is performed at one time is one line of the log data. Meanwhile, in a case where a document is included in the log data, the sensitive information may be detected across the lines. Therefore, it is preferable to hold the information on the text string of a document start point of each format in the log data and to continuously execute the conversion process.

In the embodiment described above, a hardware structure of a processing unit that executes various types of processes, such as a central control unit (not illustrated), the data acquisition unit 30, the sensitive information detection unit 31, the conversion processing unit 32, the data output unit 33, and the input reception unit 34, has various processors as described below. The various processors include a central processing unit (CPU) that is a general-purpose processor functioning as various processing units by executing software (programs), a programmable logic device (PLD) that is a processor of which a circuit configuration can be changed after manufacturing, such as a field programmable gate array (FPGA), a dedicated electrical circuit that is a processor having a circuit configuration exclusively designed to execute various processes, and the like.

One processing unit may be configured with one of the various processors or may be configured with a combination of two or more processors of the same type or different types (for example, a plurality of FPGAs or a combination of a CPU and an FPGA). Further, a plurality of processing units may be configured with one processor. As an example of a configuration in which the plurality of processing units are configured with one processor, firstly, there is an aspect in which one processor is configured with a combination of one or more CPUs and software and the processor functions as the plurality of processing units as represented by a computer such as a client, a server, or the like. Second, as represented by a system on chip (SoC) and the like, an aspect of using a processor that realize s functions of the entire system including the plurality of processing units in one integrated circuit (IC) chip is included. As described above, the various processing units are configured by using one or more of the various processors as the hardware structure.

Further, the hardware structure of these various processors is more specifically an electric circuit (circuitry) in a form in which circuit elements such as semiconductor elements are combined. In addition, a hardware structure of the storage unit is a storage device such as a hard disc drive (HDD) and a solid state drive (SSD).

### EXPLANATION OF REFERENCES

10: data transmission and reception system

11: node
11a: node
11b: node
12: device
12a: device
12b: device
13: confidential information processing apparatus
13a: confidential information processing apparatus
13b: confidential information processing apparatus
20: reception unit
21: analysis unit
22: storage unit
23: output unit
24: input reception unit
30: data acquisition unit
31: sensitive information detection unit
32: conversion processing unit
33: data output unit
34: input reception unit
40: pre-setting management unit
41: pre-setting storage unit
42: pre-setting update unit
43: specific text recognition unit
44: text string discrimination unit
45: sensitive information classification unit
46: conversion range determination unit
Ha: administrator
Hb: administrator

What is claimed is:

1. A confidential information processing apparatus comprising a processor,
wherein the processor is configured to:
acquire log data to be transmitted between apparatuses constituting a blockchain network;
discriminate a text string of the log data;
detect, as sensitive information, a text string of the log data based on a specific text set as a mark in a pre-setting, and a text string of the log data that is not discriminated based on a dictionary function for discriminating a meaningful text string; and
perform a conversion process of converting the text string of the sensitive information into a different text or symbol.

2. The confidential information processing apparatus according to claim 1,
wherein the processor is configured to:
in the log data, detect a text string including the specific text, as the sensitive information.

3. The confidential information processing apparatus according to claim 1,
wherein the processor is configured to:
in the log data, detect a text string sandwiched between the specific text or between a text string including the specific text, as the sensitive information.

4. The confidential information processing apparatus according to claim 1,
wherein the processor is configured to:
use a dictionary function for discriminating the text string of the log data; and
detect a text string sandwiched between a text string that is not discriminated based on the dictionary function, as the sensitive information.

5. The confidential information processing apparatus according to claim 1,
wherein the processor is configured to:
determine a text string after conversion by the conversion process according to a type of the sensitive information.

6. The confidential information processing apparatus according to claim 1,
wherein the processor is configured to:
in the pre-setting, apply a rule for listing the specific text, a rule for classifying a type of the sensitive information, and a rule for determining a conversion range, to the conversion process.

7. The confidential information processing apparatus according to claim 6,
wherein the processor is configured to:
in the pre-setting, apply statistical data of the past conversion process for the sensitive information, to the conversion process.

8. The confidential information processing apparatus according to claim 1,
wherein the processor is configured to:
transmit conversion-processed log data to another apparatus constituting the blockchain network; and
acquire feedback data having an analysis result of the conversion-processed log data from the other apparatus.

9. The confidential information processing apparatus according to claim 8,
wherein the processor is configured to:
in the pre-setting, receive an update of a detection target of the sensitive information based on the analysis result.

10. The confidential information processing apparatus according to claim 1,
wherein the processor is configured to:
perform the conversion process and transmission for each line of the log data, in response to a command operation by another apparatus constituting the blockchain network.

11. The confidential information processing apparatus according to claim 10,
wherein the processor is configured to:
in a case where the conversion process is performed in response to the command operation, determine a prohibited operation including an acquisition operation of the sensitive information by the other apparatus.

12. The confidential information processing apparatus according to claim 11,
wherein the prohibited operation includes, in addition to editing and deleting of the text string of the log data, any one of operation for viewing, creating, editing, or deleting a directory that is unrelated to system maintenance.

13. A data transmission and reception system comprising:
the confidential information processing apparatus according to claim 1.

14. An operation method of a confidential information processing apparatus, the method comprising:
a step of acquiring log data to be transmitted between apparatuses constituting a blockchain network;
a step of discriminating a text string of the log data;
a step of detecting, as sensitive information, a text string of the log data based on a specific text set as a mark in a pre-setting, and a text string of the log data that is not discriminated based on a dictionary function for discriminating a meaningful text string; and
a step of performing a conversion process of converting the text string of the sensitive information into a different text or symbol.
